(19) United States
(12) Patent Application Publication
(10) Pub. No.: US 2012/0007316 A1
(43) Pub. Date: Jan. 12, 2012

(54) ANNULAR SEALING DEVICE

(75) Inventor: Hiroshi Terasawa, Okayama (JP)

(73) Assignee: Uchiyama manufacturing Corp., Okayama (JP)

(21) Appl. No.: 13/258,870

(22) PCT Filed: Mar. 29, 2010
(86) PCT No.: PCT/JP2010/055518

§ 371 Date: Sep. 22, 2011

(30) Foreign Application Priority Data
Mar. 30, 2009 (JP) 2009-081335

(51) Int. Cl. F16J 15/32

(52) U.S. Cl. 277/361

(57) ABSTRACT

An annular sealing device having a core member and a seal lip member of elastic body fixed to the core member, adapted to be mounted between a metal outer member and an inner member with a flange portion in which the outer member and the inner member are concentrically provided and relatively rotate. The core member comprises a fitting cylindrical portion which is fitted to an inner circumferential portion of the outer member, an outward flange portion extending in centrifugal direction from one end of the fitting cylindrical portion, and including an abutment portion which directly contacts an end surface on the side of the flange portion of the outer member under fitted state, and an inward flange portion extending in centripetal direction from the other end of the fitting cylindrical portion. The seal lips member includes a lip base portion fixed to an area from an inner circumferential edge of the inward flange portion to an outer circumferential edge of the outward flange portion, and a plurality of annular lips to extend concentrically from the lip base portion. The annular lips include a plurality of axial lips which slidably contact the flange portion under elastically deformed state, an exterior lip formed at the radially outermost circumference so as to slidably contact or to be disposed close to the flange portion, and a gasket lip formed to project opposite to the flange portion on the radially outward side of the abutment portion and elastically contacting the end surface of the outer member along the axial direction under compressed state.

### TECHNICAL FIELD

The present invention relates to an annular sealing device and more particularly to an annular sealing device provided between an outer ring on hub flange side and a wheel hub in a hub bearing rotatably supporting automobile wheels.

### BACKGROUND ART

Automobile wheels are designed to be rotatably supported via a bearing constituted by an inner ring, an outer ring, and rolling bodies interposed between the inner ring and the outer ring. The bearing is constituted by a hub bearing comprising the outer ring fixed on vehicle body side and a wheel hub constituted as the inner ring which is fixed to a rotary (driving or driven) shaft and is rotatably supported via the rolling bodies relative to the outer ring. The wheel hub has a hub flange continuously formed at its end so as to extend in centrifugal direction and a tire wheel is fixed to the hub flange with a bolt. The outer ring may rotate in case of driven wheels, wherein the tire wheel is fixed to the outer ring and the hub flange of the inner ring is fixed to the vehicle body side. The bearing space containing the rolling bodies is sealed with an annular sealing device (seal ring) interposed between the inner ring and the outer ring, thereby preventing leakage of lubricant oil such as grease filled in the bearing space and intrusion of dust and dirty water from outside (see Patent Literature 1).

FIG. 8 shows one example of an annular sealing device (seal ring) provided on the hub flange side of the hub bearing. A seal ring 100 in FIG. 8 is provided at the end portion of a bearing space 200A on the side of a hub flange 401 of a hub bearing 200 (refer to FIG. 1 for the entire structure) having an outer ring 300 and an inner ring (wheel hub) 400 with the hub flange 401. The seal ring 100 comprises a core member 110 which is fitted under pressure to an inner circumference 301 of the outer ring 300 and a seal lip member 120 made of an elastic body (rubber) integrally fixed to the core member 110. The core member 110 has a fitting cylindrical portion 111 fitted under pressure to the inner circumference 301 of the outer ring, an outward flange portion 112 extending in centrifugal direction from one end 111a of the fitting cylindrical portion 111, and an inward flange portion 113 extending in centripetal direction from the other end 111b of the fitting cylindrical portion 111.

The seal lip member 120 comprises a lip body 121 integrally fixed to an area from an inner circumferential edge 113a of the inward flange portion 113 to an outer circumferential edge 112a of the outward flange portion 112 of the core member 110, and four annular lips 122, 123, 124, 125 extending concentrically from the lip body 121. The annular lip 122 is a radial lip (grease lip) which slidably contacts the wheel hub 400 in an elastically deformed condition and the annular lips 123, 124 are axial lips (side lips) which slidably contact the hub flange 401 in elastically deformed condition. The annular lip 125 at the outermost circumference is an exterior lip which is close to or slightly contacts the hub flange 401 and prevents intrusion of dust and dirty water into such a portion that the axial lips 123, 124 are formed. The lip body 121 wraps around the outer circumferential edge 112a of the outward flange portion 112 in a direction of the outer ring 300 and the wraparound Portion 126 is interposed between an end surface 302 on the hub flange side of the outer ring 300 and the outward flange portion 112. Patent Literature 1 discloses that the outward flange portion 112 and the outer ring 300 do not come into metallic contact because of the wraparound portion 126, thereby improving sealing performance, preventing rusting thereof, and improving durability of bearing.

Patent Literature 2 discloses a dust seal device provided between an automobile axle and a housing covering the axle. The dust seal device is constituted with a metal reinforcing ring and a rubber portion adhered to the ring by vulcanization. The metal reinforcing ring is fitted to an inner circumference of the housing covering the axle shaft and a packing portion which is formed by extending the rubber portion is interposed between the end surface of the housing and the end portion extending the outside of the metal reinforcing ring. A dust cover portion covering the outer circumferential surface of the outer end of the housing is provided in order to prevent deterioration of the sealing performance caused by rusting of the end surface of the housing.

Patent Literature 3 discloses an axle seal structure for vehicles. According to the axle seal structure, a metal ring is extended so as to form a curved piece, the curved piece is fitted to an inner circumferential surface of a wheel hub so as to closely contact the end portion of the wheel hub, and a seal lip, which closely contacts the outer circumferential surface of the wheel hub, is formed with an elastic body integrally adhered to the metal ring.

### Citation List

### Patent Literature

PTL 1: JP 2007-100826 A
PTL 2: JP H07-10631 U
PTL 3: JP S61-66265 U

### SUMMARY OF INVENTION

### Technical Problem

The seal ring 100 in FIG. 8 is fitted under pressure to the inner circumference of the outer ring 300 by operating a jig, not shown in the figure, as illustrated with an outlined arrow. The wraparound portion 126 of the seal lip member 120 is interposed between the outward flange portion 112 of the core member 110 and the end portion 302 of the outer ring 300, so that the press-fit condition is not stable by the reaction force of the wraparound portion 126 and the seal ring 100 may not be accurately positioned at an expected fitting position. Therefore, when the wheel hub 400 is incorporated, the elastic contact force of the axial lips 123, 124 to the hub flange 401 does not become a designed value and sealing performance and rotation performance (rotary torque) are affected. Furthermore, the gap or contacting degree between the exterior lip 125 and the hub flange 401 does not become stable and it affects prevention performance against intrusion of dust and dirty water therein. Furthermore, so-called rubber breakage may be caused because crushing compressing force is applied to the wraparound portion 126. Depending on the wrapping degree of the wraparound portion 126 (specifically, if the wrapping width is small), a non-uniform force is applied to the outward flange portion 112 in case of press fitting, thereby making the core member 110 deformed.

The exterior lip 125 is designed to be provided close to the hub flange 401 or is provided so as to slightly contact the hub flange 401 in order to prevent intrusion of dust and dirty water into such a portion that the axial lips 123, 124 are formed. The side 401a in the centrifugal direction of the hub flange 401 is often formed like a step as shown in the figure according to of the structure of the hub bearing 200. For the reason, the extended width of the exterior lip 125 is required to be large. As a result, there is such a problem that the shape holding performance of the exterior lip 125 is deteriorated.

According to the dust seal device in Patent Literature 2, the packing portion which is formed by extending the rubber portion is interposed between the end surface of the housing and the metal reinforcing ring, so that the above-mentioned problem can be anticipated when the metal reinforcing ring is fitted under pressure.

According to the axle seal structure disclosed in Patent Literature 3, the curved piece of the metal ring comes into metallic contact with the end of the wheel hub, so that the above-mentioned problem in case of press-fit is not caused. However, the seal lip provided for compensating the sealing performance of the metallic contact portion only closely contacts the outer circumferential surface of the wheel hub, it does not have a gasket function accompanying elastic deformation by compression, and it is assumed that such a structure is not sufficient for improving the sealing performance of the metallic contact portion.

The present invention is proposed in view of the above-mentioned problems and has an object to provide an annular sealing device which can improve the sealing performance of the metallic contact portion and is applicable to any shape characteristic of an object to be sealed with a simple structure.

### Solution to Problem

According to the present invention, an annular sealing device having a core member and a seal lip member of elastic body fixed to the core member is adapted to be mounted between a metal outer member and an inner member with a flange portion in which the outer member and the inner member are concentrically provided and relatively rotate. The core member comprises a fitting cylindrical portion which is fitted to an inner circumferential portion of the outer member, an outward flange portion extending in centrifugal direction from one end of the fitting cylindrical portion, and including an abutment portion which directly contacts an end surface on the side of the flange portion of the outer member under fitted state, and an inward flange portion extending in centripetal direction from the other end of the fitting cylindrical portion. The seal lip member includes a lip base portion fixed to an area from an inner circumferential edge of the inward flange portion to an outer circumferential edge of the outward flange portion of the core member, and a plurality of annular lips formed to extend concentrically from the lip base portion. The annular lips include a plurality of axial lips which slidably contact the flange portion under elastically deformed state, an exterior lip formed at the radially outermost circumference so as to slidably contact or to be disposed close to a flange portion, and a gasket lip formed to project opposite to the flange portion on the radially outward side of the abutment portion and elastically contacting the end surface of the outer member along the axial direction under compressed state.

According to the present invention, a non-abutment portion where the outward flange portion and the end surface of the outer member do not contact can be provided on the radially outward side of the abutment portion of the outward flange portion, and the gasket lip can be interposed under compressed state at the non-abutment portion between the outward flange portion and the end surface of the outer member. In such a case, the non-abutment portion can be constituted by a curved portion where the outward flange portion is bent apart from the end surface of the outer member on the radially outward side of the abutment portion. Or the non-abutment portion is constituted such that the end surface of the outer member is removed on the radially outward side of the abutment portion by being ground so as to be apart from the outward flange portion on the radially outward side of the abutment portion.

According to the present invention, the outer circumferential edge of the outward flange portion can project radially outward from the radially outermost portion of the end surface of the outer member.

According to the present invention, the lip base portion between the exterior lip and the gasket lip can be fixed to the core member in a manner that the lip base straddles the outer circumferential edge of the outward flange portion.

According to the present invention, a depression for relief can be provided at a base portion of the gasket lip.

Furthermore according to the present invention, the annular sealing device can be designed to seal a bearing space of a hub bearing. In such a case the outer member is an outer ring of the hub bearing, the inner member is a wheel hub as an inner ring of the hub bearing, and the flange portion is a hub flange constituting a part of the wheel hub.

### Advantageous Effects of Invention

According to the present invention, the annular sealing device is provided between the outer member and the inner member having a flange portion which are concentric and relatively rotate. In such a condition, the fitting cylindrical portion of the core member is fitted to the inner circumferential portion of the outer member and a plurality of axial lips among the annular lips constituting the seal lip member slidably contacts the flange portion of the inner member in elastically deformed condition, so that the space between the outer member and the inner member which relatively rotate can be sealed. The exterior lip at the outermost circumference is formed so as to slidably contact or to be close to the flange portion, so that dust and dirty water are prevented from entering such a portion that the axial lips are formed and abrasion does not occur at portions where the axial lip slidably contacts under elastically deformed condition, thereby keeping the seal function for a long time. The exterior lip only slidably contacts or is disposed close to the flange portion, whereby there is no fear of increasing the rotary torque.

The outward flange portion of the core member includes an abutment portion which directly abuts the end surface on the flange portion side when being fitted to the outer member, so that the abutment portion becomes metallic contact, the annular sealing device of the present invention can be accurately fitted to an expected position, and an intended seal function can be surely achieved. Furthermore, the gasket lip constituted as the annular lip is formed so as to project opposite to the flange portion on the radially outward side of the abutment portion and is constituted so as to elastically contact the end surface of the outer member along the axial direction in compressed condition. Therefore, the gasket lip is interposed in compressed condition in the radially outward side of the abutment portion in case of such fitting and the sealing performance of the abutment portion which becomes metallic contact can be compensated. Therefore, intrusion of dirty water and the like into the objective portion to be sealed from the fitting portion of the outer member and the core member, which constitute metallic contact, is surely prevented.

When the non-abutment portion is formed in the radially outward side of the abutment portion by either the curved portion or the grinded portion and furthermore the gasket lip is constituted so as to be interposed between the outward flange portion and the end surface of the outer member at the non-contacting portion in compressed condition, the gasket lip is compressed in case of fitting the fitting cylindrical portion of the core member to the inner circumferential portion of the outer member and the sealing performance at the fitting portion can be surely obtained by the contact pressure accompanying the reaction force. The fitting portion constitutes sealing between stationary bodies and there is no fear of increasing the rotary torque by the reaction force caused by compression.

When the outer circumferential edge of the outward flange portion projects in the radially outward direction from the radially outermost portion of the end surface of the outer member, the extending width of the exterior lip is not required to be so large by forming the exterior lip from the outer circumferential edge as a start point because of the shape characteristic of the flange portion even if the flange portion is apart from the end surface of the outer member, thereby forming the exterior lip while keeping its shape characteristic. The tip end of the exterior lip extends in further centrifugal direction, thereby improving the sealing performance between the outer member and the inner member. Furthermore, the gasket lip and the exterior lip become apart, so that compression of the gasket lip does not affect the exterior lip in case of the above-mentioned press-fitting, and there is no possibility that the exterior lip rises by the press-fitting.

Furthermore, when the lip base portion between the exterior lip and the gasket lip is fixed to the core member so as to cover the outer circumferential edge of the outward flange portion, the fixing strength of the fixed portion increases and the outer circumferential edge is enclosed with the lip base portion. Therefore, there is no fear of rusting of the outward flange portion and the core member, thereby improving the durability of the sealing device.

When the base portion of the gasket lip is provided with the concave relief, compression of the gasket lip caused by the fitting hardly affects the exterior lip and there is no possibility of rising of the exterior lip.

When the annular sealing device of the present invention seals the bearing space of the hub bearing, the above-mentioned problems specific to the seal ring (annular sealing device) on the hub flange side of the hub bearing are solved, the sealing performance in the bearing space of the hub bearing is improved, there is no above-mentioned defects in case of assembling the hub bearing, and assembly procedure can be rationalized.

### BRIEF DESCRIPTION OF DRAWINGS

FIG. 1 is a vertical sectional view showing one embodiment of a bearing incorporating one embodiment of a sealing device of the present invention.

FIG. 2 is an enlarged view of “X” in FIG. 1 and includes a further enlarged view of the essential part.

FIG. 3 is a similar view to the enlarged view in FIG. 2 and shows a modified example of the same embodiment.

FIG. 4a is a similar view to FIG. 3 and shows another embodiment and FIG. 4b is the similar view showing its modified example.

FIG. 5a is a similar view to FIG. 3 and shows another modified example of the embodiment in FIG. 4a and FIG. 5b is the similar view showing a modified example of FIG. 4b.

FIG. 6a is a similar view to FIG. 3 and shows another embodiment, and FIG. 6b is the similar view showing its modified example.

FIG. 7 is a similar view to FIG. 3 and shows another modified example of the embodiment in FIG. 2.

FIG. 8 is a similar view to FIG. 2 and shows a prior sealing device.

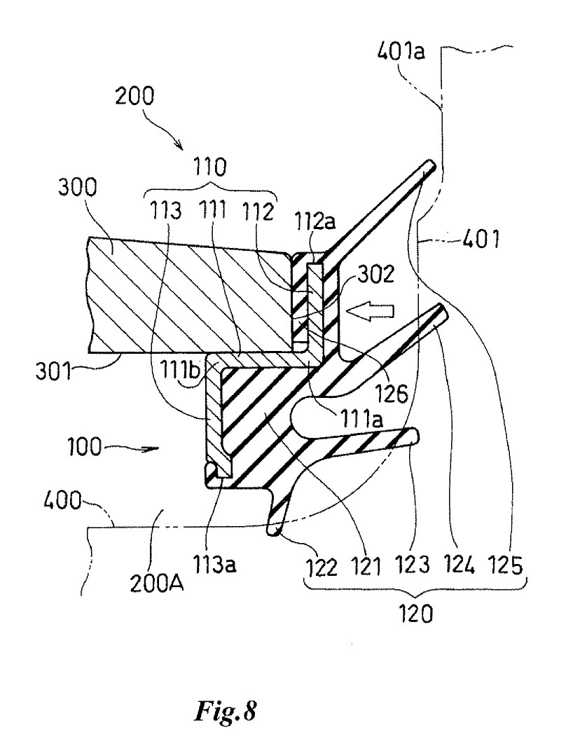

### DESCRIPTION OF EMBODIMENTS

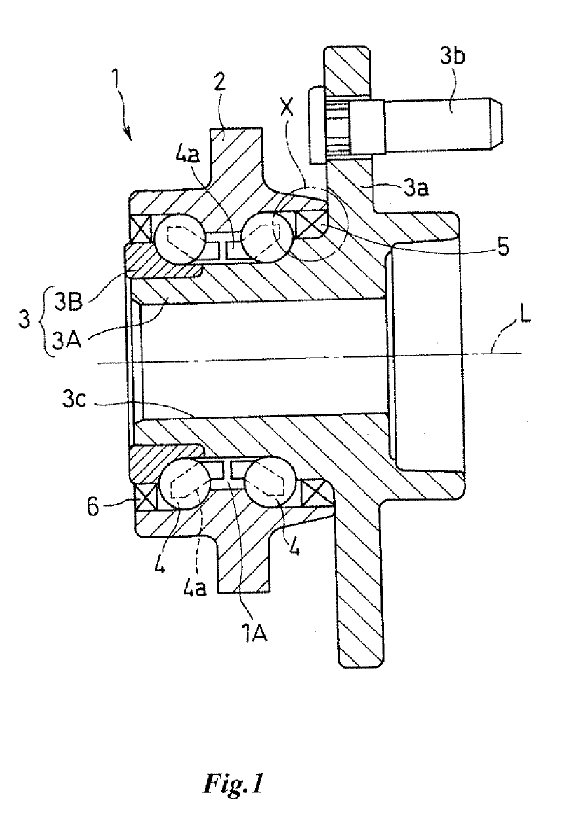

The embodiments of the present invention are explained referring to the attached drawings. FIG. 1 shows one embodiment of the construction of a hub bearing 1 rotatably supporting automobile wheels in which an outer ring (outer member) 2 is fixed to a suspension system (not shown) of a vehicle body. A tire wheel (not shown) is fixed to a hub flange (flange portion) 3a of a wheel hub 3A constituting an inner ring (inner member) 3 with a bolt 3b. A drive shaft (not shown) is spline-fitted to a spline axis hole 3c formed on the wheel hub 3A and the rotary driving force of the driving shaft is transmitted to the tire wheel. The wheel hub 3A constitutes the inner ring 3 together with an inner member 3B. Two rows of rolling bodies (balls) 4 . . . are held with a retainer 4a and interposed between the outer ring 2 and the inner ring 3. A bearing space 1A is defined by the rolling bodies 4 . . . and each orbit surface formed on the inner and outer rings 2, 3, and the inner ring 3 is rotatably supported to the outer ring 2 via the bearing space 1A. When the shaft is driven and rotated, the shaft can freely rotate together with the wheel hub 3A with respect to the outer ring 2. Outside of an axial center L of the orbit surface of the two rows of rolling bodies (balls) 4 . . . , namely both sides along the axial center L of the bearing space 1A, seal rings (sealing devices) 5, 6 are provided under pressure between the outer ring 2 and the inner ring 3 for preventing leakage of lubricant agent (grease) filled in a rolling portion (bearing space 1A) of the rolling bodies 4 . . . and for preventing intrusion of dirty water, dust and the like from outside.

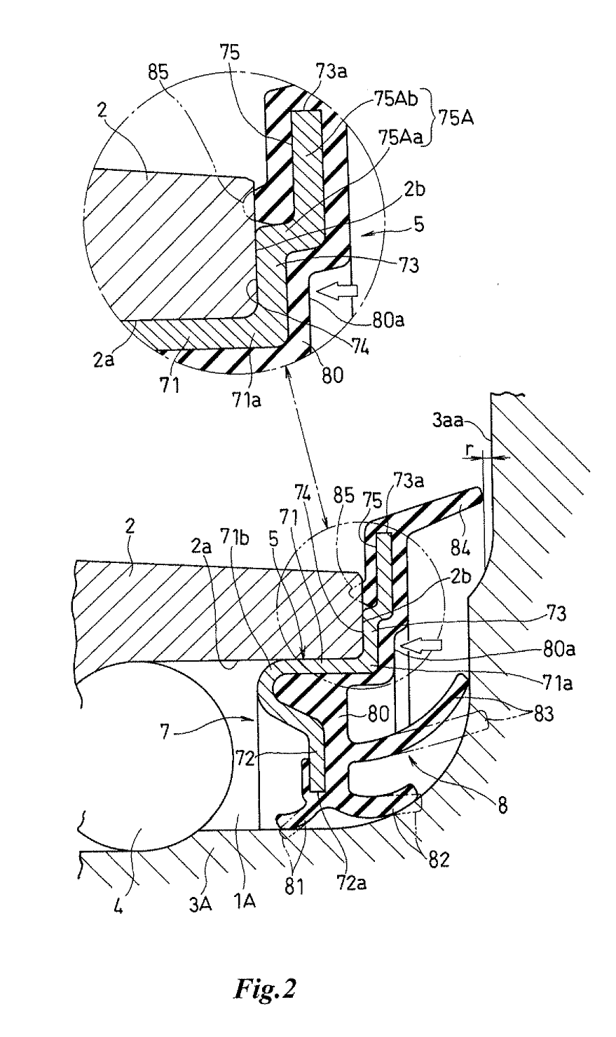

FIG. 2 shows an enlarged sectional view of the portion where the seal ring 5 is attached opposite to the vehicle body (outer side) and also shows an enlarged view of the essential part. Now, the structure of the seal ring 5 is explained referring to FIG. 2. The seal ring 5 comprises a core member 7 which is integrally fitted under pressure to the inner circumference 2a of the outer ring 2 and a seal lip member 8 which is integrally fixed to the core member 7 and has annular lips 81 to 85. The core member 7 has a fitting cylindrical portion 71 which is fitted under pressure to the inner circumference 2a of the outer ring 2, an outward flange portion 73 which is continuously formed at its one end 71a of the fitting cylindrical portion 71 so as to extend in its centrifugal direction, and an inward flange portion 72 which is connected from the other end 71b of the fitting cylindrical portion 71 and extends in centripetal direction. The outward flange portion 73 has an abutment portion 74 which directly abuts an end surface 2b on the hub flange 3a side of the outer ring 2 when the fitting cylindrical portion 71 of the core member 7 is fitted under pressure to the outer ring 2 and it has a non-abutment portion 75 which is connected on the radially outward side of the abutment portion 74 and does not abut the end surface 2b. The non-abutment portion 75 is constituted with a curved portion 75A comprised of a short cylindrical portion 75Aa and an annular disc portion 75Ab formed so as to jut toward the hub flange 3a via the short cylindrical portion 75Aa.

The seal lip member 8 includes a lip base portion 80 integrally fixed to an area of the core member 7 from the inner circumferential edge 72a of the inward flange portion 72 to the outer circumferential edge 73a of the outward flange portion 73 and includes five annular lips 81 to 85 extended concentrically from the lip base portion 80. The seal lip member 8 in the figure is constituted with a molded body made of rubber and is formed by vulcanization molding of a rubber material to the core member 7. The annular lip 81 is a radial lip (grease lip) and its diameter is reduced in centripetal direction into the bearing space 1A from a portion wrapping around the inner circumferential edge 72a so as to be formed like a cylindrical cone along the axial center L. The annular lip 81 is formed so as to slidably contact the circumferential surface of the wheel hub 3A in elastically deformed condition when assembled to the hub bearing 1. The annular lips 82, 83 are axial lips and their diameter is enlarged into the centrifugal direction opposite to the bearing space 1A from the lip base portion 80 so as to form concentric circular cones along the axial center L. The annular lips 82, 83 are formed so as to slidably contacts the disc surface of the hub flange 3a in elastically deformed condition from a rising portion of the hub flange 3a when assembled to the hub bearing 1.

The radial lip 81 and the axial lips 82, 83 slidably contact the wheel hub 3A in elastically deformed condition, thereby preventing leakage of lubricant oil such as grease filled in the bearing space 1A and intrusion of dirty water and dust into the bearing space 1A from outside, keeping a rotatable supporting relation of the inner ring 3 to the outer ring 2, and contributing long life of the hub bearing 1.

The annular lip 84 at the outermost circumference is an exterior lip, is directed to the hub flange 3a from the lip base portion 80 around the outer circumferential edge 73a, is enlarged into the centrifugal direction, and is formed as a concentric cylindrical cone around the axial center L. The exterior lip 84 is formed so as to slidably contact or to be close to a stepped portion 3aa formed on the centrifugal side of the hub flange 3a. The exterior lip 84 faces the surface of the stepped portion 3aa with a small gap “r” in FIG. 2; however, it may slightly contact the stepped portion 3aa. As a result, dirty water and dust are prevented from entering from outside to such a portion that the axial lips 82, 83 are formed. Therefore, the tip ends of the axial lips 82, 83 do not become worn if dust gets stuck into such a portion that the axial lips 82, 83 contact the hub flange 3a in elastically deformed condition, thereby attributing long life of the axial lips 82, 83.

The annular lip 85 is formed so as to project opposite to the hub flange 3a (opposite side of the hub flange 3a) at the radially outward side of the abutment portion 74, namely at the non-abutment portion 75 and is a gasket lip attached so as to elastically contact the end surface 2b of the outer ring 2 along the axial center L direction. The gasket lip 85 elastically contacts the end surface 2b in compressed condition, so that the contact area is sealed and intrusion of dirty water into the bearing space 1A from the fitting portion of the core member 7 and the outer ring 2 is prevented. The radial lip 81, the axial lips 82, 83 and the gasket lip 85 shown with dotted lines in FIG. 2 illustrate their initial shapes before they are elastically deformed.

The lip base portion 80 between the exterior lip 84 and the gasket lip 85 is integrally fixed to the core member 7 so as to cover (wrap-around) the outer circumferential edge 73a of the outward flange portion 73. Accordingly, the base portion of the exterior lip 84 and the gasket lip 85 is firmly integrated to the core member 7. Because the outer circumferential edge 73a is covered with the lip base portion 80, rusting of the outward flange portion 73 and the like is prevented. Furthermore, the outer circumferential edge 73a of the outward flange portion 73 is formed so as to further project radially outward direction than the radially outermost portion of the end surface 2b of the outer ring 2. Therefore, even if the hub flange 3a has the stepped portion 3aa as shown in the figure, the distance between the outer circumferential edge 73a as an origin of the exterior lip 84 does not substantially become large and the projecting distance of the exterior lip 84 is not required to be so large. Therefore, the exterior lip 84 can keep the shape retention performance. The tip end of the exterior lip 84 is further extended in centrifugal direction, thereby improving seal performance between the outer ring 2 and the inner ring 3. Furthermore, the gasket lip 85 and the exterior lip 84 are adapted to be separated, so that compression of the gasket lip 85 does not affect the exterior lip 84 in case of press-fit and the exterior lip 84 hardly rises.

The fixed portion of the lip base portion 80 on the hub flange 3a side of the abutment portion 74 becomes an operating portion 80a of a jig (not shown) in case of press-fit of the seal ring 5 to the inner circumference 2a of the outer ring 2 by operating the jig as shown with the outlined arrow. Namely, the jig works on the acting portion 80a as shown with the outlined arrow and the abutment portion 74 is pressed to abut the end surface 2b of the outer ring 2 and is fitted therein. The gasket lip 85 is compressed along the axial center direction L and is interposed between the non-abutment portion 75 and the end surface 2b under compressed condition. Therefore, the space between the non-abutment portion 75 and the end surface 2b is completely sealed by the action of the contact pressure caused by the elastic deformation in case of such compression, thereby preventing intrusion of dirty water and dust into the metallic contact portion of the abutment portion 74 and the end surface 2b and the metallic fitting portion of the fitting cylindrical portion 71 and the outer ring 2. The gasket lip 85 becomes compressed in the space between the non-abutment portion 75 and the end surface 2b, so that a relief of rubber constituting the gasket lip 85 is secured and elastic deformation of the gasket lip 85 by compression is smoothly executed.

The abutment portion 74 achieves metallic contact with the end surface 2b, when they are fitted in such a manner that the abutment portion 74 surely abuts the end surface 2b, the seal ring 5 can be accurately and desirably positioned to be fitted. Therefore, when the wheel hub 3A is incorporated, the elastic force of the axial lips 82, 83 to the hub flange 3a becomes a designed value and the seal performance and the rotary performance (rotary torque) of the axial lips 82, 83 can be kept at desired values. Furthermore, the small gap “r” between the exterior lip 84 and the stepped portion 3aa of the hub flange 3a can be kept at a designed value and function of preventing intrusion of dirty water and dust at this portion can be kept at designed condition.

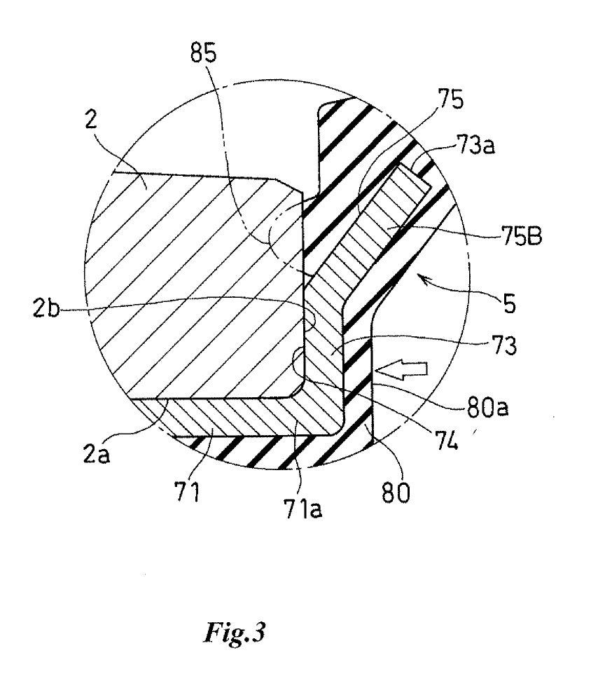

FIG. 3 shows a modified example of the non-abutment portion 75. The non-abutment portion 75 is constituted with a tapered portion (bent portion) 75B which gradually extends in radially outward direction, namely in centrifugal direction, into the hub flange 3a from the radially outward side of the abutment portion 74. The gasket lip 85 projects opposite to the hub flange 3a on the radially outward side of the abutment portion 74, namely at the non-abutment portion 75, as mentioned above. Therefore, when the jig works on the operating portion 80a as shown with the outlined arrow and the seal ring 5 is fitted under pressure to the inner circumference 2a of the outer ring 2, the gasket lip 85 is compressed between the non-abutment portion 75 and the end surface 2b of the outer ring 2, thereby achieving the above-mentioned sealing function. Other structures are the same as those mentioned above, the same reference signs are allotted to the common members and their explanation is omitted.

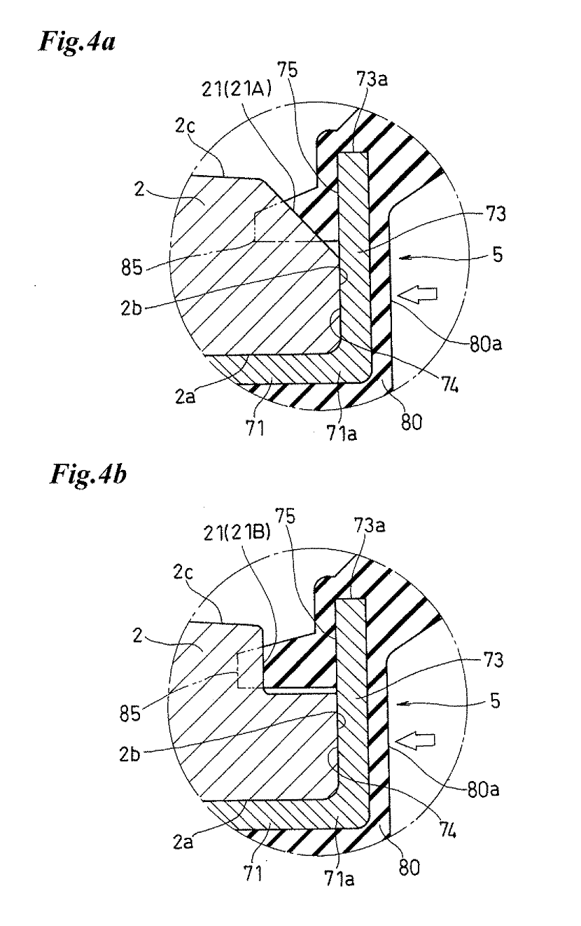

FIG. 4a and FIG. 4b show another embodiment of the non-abutment portion 75. In each embodiment, the outward flange portion 73 of the core member 7 is a plain plate and the non-abutment portion 75 is substantially formed by the ground portion 21 which is formed by grinding the end surface 2b of the outer ring 2 at radially outward portion of the abutment portion 74 so as to be apart from the outward flange portion 73. The ground portion 21 in FIG. 4a is a tapered portion 21A formed by chamfering the corners of the end surface 2b of the outer ring 2 and the outer circumference 2c. The ground portion 21 in FIG. 4b is a stepped portion 21B formed by circularly grinding the angles of the end surface 2b of the outer ring 2 and the outer circumference 2c. When the jig works on the operating portion 80a as illustrated with the outlined arrow and the seal ring 5 is fitted under pressure to the inner circumference 2a of the outer ring 2 in each embodiment, the gasket lip 85 is compressed between the non-abutment portion 75 and the end surface 2b (tapered portion 21A, stepped portion 21B) of the outer ring 2, thereby achieving the above-mentioned sealing function. The outward flange portion 73 is a plain plate in each case, so that the operating portion 80a can be widely obtained as shown in the figure and it is advantageous that the workability in case of press-fit as mentioned above becomes superior. Other structures are the same as those mentioned above, the same reference signs are allotted to the common members and their explanation is omitted.

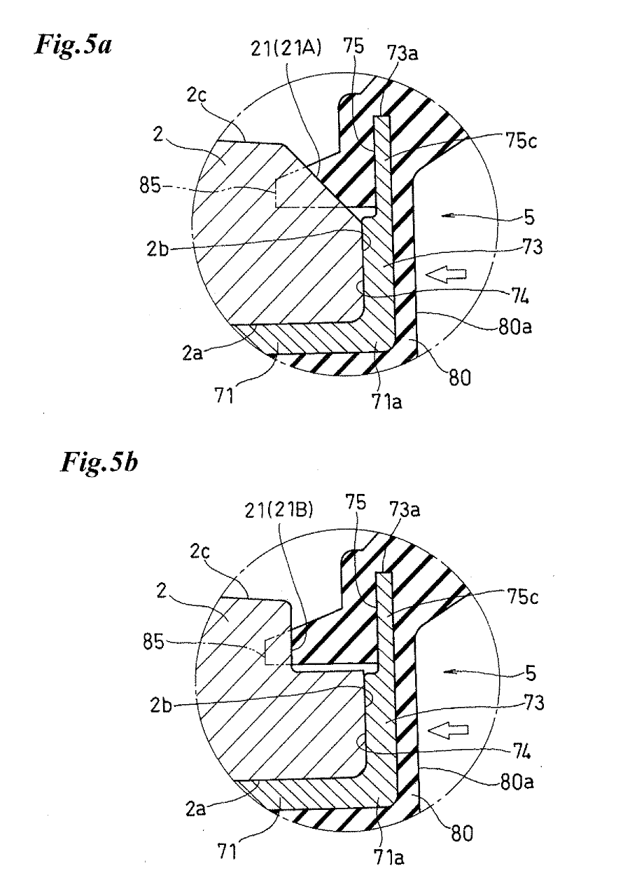

FIG. 5a and FIG. 5b are modified examples of FIG. 4a and FIG. 4b, respectively. Basic structures of the non-abutment portion 75 in these examples are the same as those in FIG. 4a and FIG. 4b; however, they are different in that a thin portion 75C is formed by depressing the outer ring side 2 of the non-abutment portion 75 of the outward flange portion 73. The compression space of the gasket lip 85 becomes wide by forming such a thin portion 75C and the relief for the rubber at compression can be largely secured, and smoothability of elastic deformation of the gasket lip 85 by compression is improved. Other structures are the same as those in FIG. 4a and FIG. 4b, the same reference signs are allotted to the common members and their explanation is omitted.

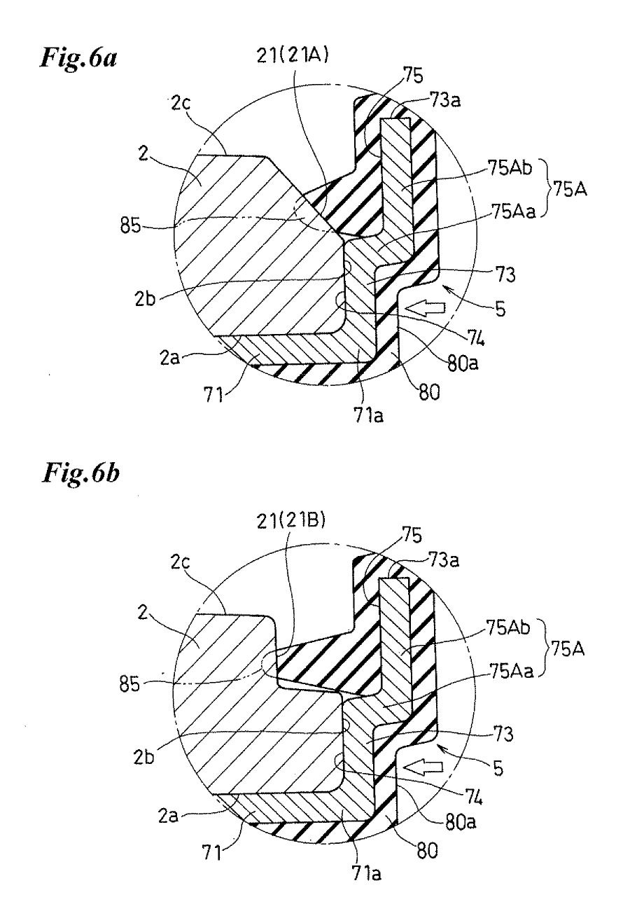

FIG. 6a and FIG. 6b show another embodiments of the non-abutment portion 75. These embodiments are a combination of the embodiment in FIG. 2 and the embodiment in FIG. 4a or FIG. 4b. Namely, in the embodiment in FIG. 6a, the non-abutment portion 75 is constituted with the stepped curved portion 75A formed on the outward flange portion 73 of the core member 7 and the tapered ground portion 21 (21A) formed on the outer ring 2. In the embodiment in FIG. 6b, the non-abutment portion 75 is constituted with the stepped curved portion 75A formed on the outward flange portion 73 of the core member 7 and the stepped ground portion 21 (21B) formed on the outer ring 2. In each embodiment, the compression space of the gasket lip 85 is largely secured and the smoothability of elastic deformation by compression of the gasket lip 85 is improved. Other structures are the same as those mentioned above, the same reference signs are allotted to the common members and their explanation is omitted. The non-abutment portion 75 can be formed by the curved portion 75B in FIG. 3 and the ground portion 21 (21A or 21B) in the embodiments of FIG. 4a and FIG. 4b in the same manner as mentioned above, although they are not exemplified. In addition, the thin portion 75C can be also used.

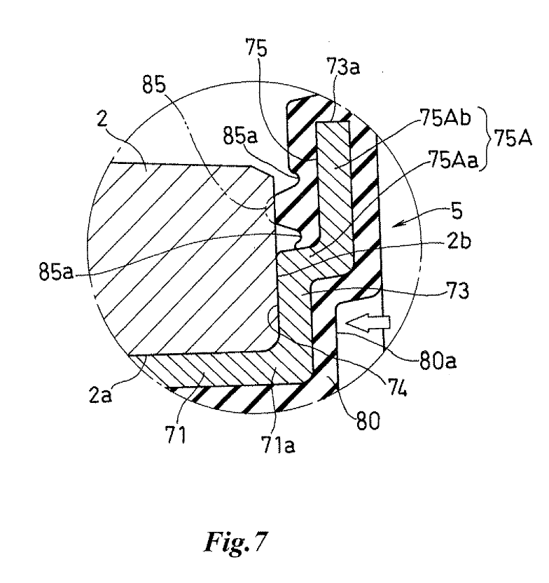

FIG. 7 is another embodiment of FIG. 2 in which concave reliefs 85a, 85a are formed at both sides of the gasket lip 85. Compression of the gasket lip 85 in case of press-fit does not affect the exterior lip 84 by providing the reliefs 85a, 85a, thereby eliminating possibility of rising of the gasket lip 85. In this case, the reliefs 85a, 85a are formed on both sides of the base portion of the gasket lip 85; however, one relief 85a may be provided on the outer circumference side. Such reliefs 85a, 85a can be applied to the embodiments in FIG. 3 to FIG. 6. Other structures are the same as those mentioned above, the same reference signs are allotted to the common members and their explanation is omitted.

The sealing device of the present invention is exemplified as the seal ring 5 of the hub bearing 1 in these embodiments; however, it can be applied to the sealing device for an axle shaft which is similarly constituted. In addition to the seal lip member 8 explained as a vulcanization molded body made of rubber, it can be a molded body of elastic synthetic resin. Furthermore, the shape (including number) of each annular lip and the shape of the core member 7 are not limited to those shown in the figures. The annular sealing device of the present invention can be also used for the hub bearing in which the outer ring is rotated.

### REFERENCE SIGNS LIST

1 hub bearing
1A bearing space
2 outer ring (outer member)
2a inner circumference of outer ring (outer member)
21 (21A) ground portion
21 (21B) ground portion
3 inner ring (inside member)
3A wheel hub
3a hub flange (flange portion)
5 seal ring (sealing device)
7 core member
71 fitting cylindrical portion
71a one end
71b other end
72 inward flange portion
72a inner circumferential edge
73 outward flange portion
73a outer circumferential edge
74 abutment portion
75 non-abutment portion
75A curved portion
75B curved portion
8 seal lip portion
80 lip base
82, 83 axial lip (annular lip)
84 exterior lip (annular lip)
85 gasket lip (annular lip)
85a relief

1. An annular sealing device having a core member and a seal lip member of elastic body fixed to said core member, adapted to be mounted between a metal outer member and an inner member with a flange portion in which said outer member and said inner member are concentrically provided and relatively rotate, wherein
said core member comprises:
a fitting cylindrical portion which is fitted to an inner circumferential portion of said outer member;
an outward flange portion extending in centrifugal direction from one end of said fitting cylindrical portion, and including an abutment portion which directly contacts an end surface on the side of said flange portion of said outer member under fitted state; and
an inward flange portion extending in centripetal direction from the other end of said fitting cylindrical portion;
said seal lip member includes:
a lip base portion fixed to an area from an inner circumferential edge of said inward flange portion to an outer circumferential edge of said outward flange portion of said core member; and
a plurality of annular lips formed to extend concentrically from said lip base portion; and
said annular lips include:
a plurality of axial lips which slidably contact said flange portion under elastically deformed state;
an exterior lip formed at a radially outermost circumference so as to slidably contact or to be disposed close to said flange portion; and
a gasket lip formed to project opposite to said flange portion on the radially outward side of said abutment portion and elastically contacting said end surface of said outer member along the axial direction under compressed state.

2. The annular sealing device as set forth in claim 1, wherein a non-abutment portion where said outward flange portion and said end surface of said outer member do not contact is provided on the radially outward side of said abutment portion of said outward flange portion, and wherein said gasket lip is interposed under compressed state at said non-abutment portion between said outward flange portion and said end surface of said outer member.

3. The annular sealing device as set forth in claim 2, wherein said non-abutment portion is constituted by a curved portion where said outward flange portion is bent apart from said end surface of said outer member on the radially outward side of said abutment portion.

4. The annular sealing device as set forth in claim 2, wherein said non-abutment portion is constituted such that said end surface of said outer member is removed on the radially outward side of said abutment portion by being ground so as to be apart from said outward flange portion on the radially outward side of said abutment portion.

5. The annular sealing device as set forth in claim 1, wherein said outer circumferential edge of said outward flange portion projects radially outward from said radially outermost portion of said end surface of said outer member.

6. The annular sealing device as set forth in claim 1, wherein said lip base portion between said exterior lip and said gasket lip is fixed to said core member in a manner that said lip base portion straddles said outer circumferential edge of said outward flange portion.

7. The annular sealing device as set forth in claim 1, wherein a depression for relief is provided at a base portion of said gasket lip.

8. The annular sealing device as set forth in claim 1, wherein said annular sealing device seals a bearing space of a hub bearing, and wherein said outer member is an outer ring of said hub bearing, said inner member is a wheel hub as an inner ring of said hub bearing, and said flange portion is a hub flange constituting a part of said wheel hub.
